(19) United States
(12) Patent Application Publication
(10) Pub. No.: US 2024/0316793 A1
(43) Pub. Date: Sep. 26, 2024

(54) SEGMENTED VACUUM GRIPPER SEALING ELEMENT

(71) Applicant: Nemo Power Tools Ltd., Sheung Wan (HK)

(72) Inventor: Nimrod Rotem, Sheung Wan (HK)

(21) Appl. No.: 18/126,086

(22) Filed: Mar. 24, 2023

(51) Int. Cl. B25J 15/06; B25B 11/00

(52) U.S. Cl. CPC B25J 15/0683; B25B 11/007

(57) ABSTRACT

A segmented sealing element for use with a vacuum gripper improves performance when gripping surfaces with irregular topologies or extensive porosity. A contact surface of the segmented sealing element incorporates a degree of granularity by conforming to a segmentation pattern which divides the sealing element into a plurality of compressible segments. The individual compressible segments conform to one or more irregular physical features of an object surface when the contact surface is pressed thereagainst during vacuum gripper operation.

### CROSS-REFERENCE TO RELATED APPLICATIONS

This application is related to U.S. Pat. No. 11,413,727 which is incorporated by reference herein.

### FIELD OF TECHNOLOGY

This disclosure relates generally to vacuum-assisted gripping devices and, more particularly, to a segmented sealing element usable therewith which improves vacuum gripping performance over irregular surface topologies.

### BACKGROUND

Vacuum gripping technology is used to facilitate lifting objects which are unwieldy or otherwise do not have handles. However, vacuum gripper sealing elements generally perform poorly when used on objects with rough or porous textures, grooves, protrusions, or any other irregular surface topology. U.S. Pat. No. 11,413,727 (hereinafter '727) describes a vacuum gripper which chiefly comprises a rigid base element (base element 141) and a loop-shaped vacuum seal element (seal element 145) attached thereto. Although the seal element 145 is elastically deformable when pressed against the surface of an object, the contact surface of the seal element is continuous, which prevents it from conforming closely with the topology of an irregular surface. When pressed against an irregular surface, the contact surface exhibits a “surface tension” which prevents it from stretching beyond a certain limit and filling in or around irregularities in the object surface. The continuity of the contact surface is intended by design—against continuous surfaces, it prevents the vacuum conditions created by the vacuum gripper and sealing element from being compromised. However, when used against an irregular surface, a continuous contact surface leaves gaps within or around the irregularities because the ‘surface tension’ of the material prevents it from stretching beyond a certain limit.

Thus, there exists a need for a more granular sealing element, which is able to conform to any surface topology, including sharp corners and features such as deep grooves, routed channels, as well as the transverse of these geometries, such as sharp, angled protrusions.

### SUMMARY

Disclosed is a segmented sealing element for use with a vacuum gripper to improve performance thereof on irregular surfaces.

In one aspect, a vacuum gripper sealing element utilizes a mounting surface of the sealing element mountable to a receiving surface of a vacuum gripper base element. The sealing element additionally involves a contact surface of the sealing element opposite to the mounting surface and joined to the mounting surface through an outer edge and an inner edge. The sealing element also incorporates a segmentation pattern dividing the sealing element into a plurality of compressible segments which individually conform to one or more irregularities of an object surface when the contact surface is pressed thereagainst.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a perspective view of an exemplary vacuum gripper, according to one or more embodiments.

FIG. 2 is a bottom view of a base element of the vacuum gripper of FIG. 1, according to one or more embodiments.

FIG. 3 is an exemplary sealing element mountable to the base element of FIG. 2, according to one or more embodiments.

FIG. 4 is a cross-section diagram of the sealing element of FIG. 3, according to one or more embodiments.

FIGS. 5a-5b show a cross-section view and a contact surface view respectively of a sealing element with an angled segmentation pattern, according to one or more embodiments.

FIGS. 6a-6b show a cross-section view and a contact surface view respectively of a sealing element with a straight cut segmentation pattern, according to one or more embodiments.

FIGS. 7a-7b show a cross-section view and a contact surface view respectively of a sealing element with a full pass segmentation pattern, according to one or more embodiments.

FIGS. 8a-8b show a cross-section view and a contact surface view respectively of a sealing element with a segmented contact surface, according to one or more embodiments.

FIGS. 9a-9b show a cross-section view and a contact surface view respectively of a sealing element with a segmented outer edge and/or a segmented inner edge, according to one or more embodiments.

FIG. 10 is a perspective view of an exemplary rough, porous surface having one or more grooves, according to one or more embodiments.

FIG. 11 is a cross-section view of the rough, porous surface showing groove detail, according to one or more embodiments.

FIG. 12a is a cross-section diagram of a sealing element having a segmented contact surface, according to one or more embodiments.

FIG. 12b is a cross-section diagram of the sealing element of FIG. 12a in contact with the rough, porous surface of FIG. 11, according to one or more embodiments.

FIG. 12c is a cross-section diagram of an exemplary sealing element having a continuous contact surface without a segmentation pattern, according to one or more embodiments.

Other features of the present embodiments will be apparent from the accompanying drawings and from the detailed description that follows.

### DETAILED DESCRIPTION

Example embodiments, as described below, may be used to provide a segmented sealing element featuring a granular contact surface which more closely conforms to irregular surface topology compared to contemporary sealing elements. The segmented sealing element may be mounted to a base element of a vacuum gripper such as the vacuum gripper described in U.S. Pat. No. 11,413,727. Although the segmented sealing element is used to improve the performance of a vacuum gripper, it should be appreciated that the segmented sealing element is applicable wherever a tight seal is desired on rough, porous surfaces such as a paving stone, a cinderblock, medium-density fiberboard, and other object surfaces.

The segmented sealing element comprises a segmentation pattern which causes portions of the sealing element to be partially separable from each other. ‘Partially separable’ may refer to a structural property of an object that involves portions of it to move apart from each other or past each other limitedly although the portions themselves are still connected to and are part of the whole object. A sealing element that includes a segmentation pattern may comprise partially separable portions that constitute a non-continuous contact surface. Although this seems counter-intuitive at first—a continuous surface is usually desired to provide a tight seal on flat or gradually changing surfaces—it is preferable to use a non-continuous contact surface against an object surface with irregularities so that the individual partially separable elements of the contact surface can conform appropriately to the typically sharp changes in irregular surface topology.

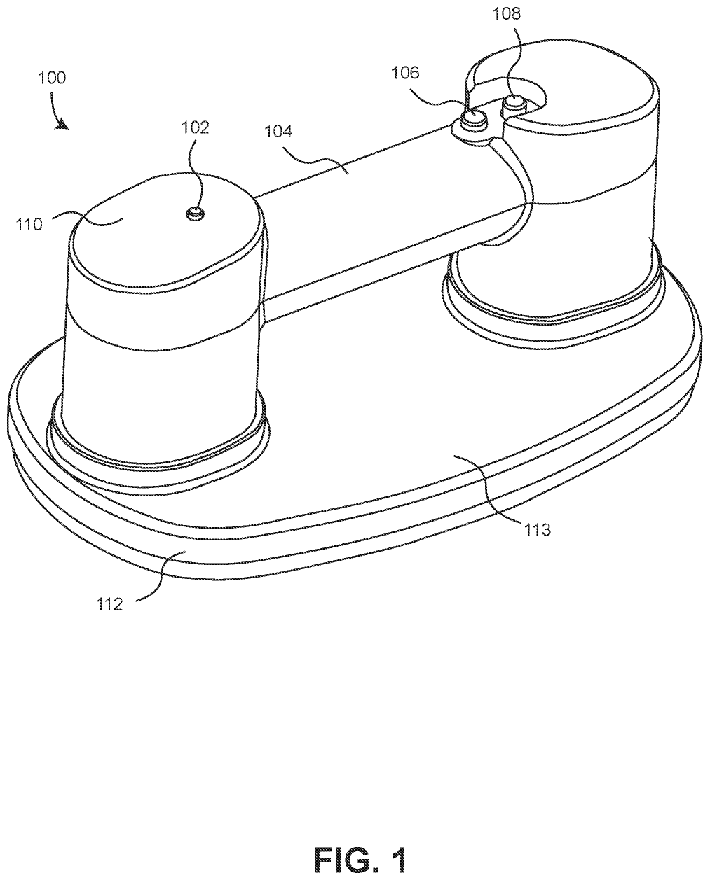

Reference is made to FIG. 1 which is a perspective view of an exemplary vacuum gripper 100, according to one or more embodiments. In one embodiment, the vacuum gripper 100 may comprise an automatic power on/off switch 102, a handle 104, a manual power switch 106, a release button 108 (for manually interrupting vacuum conditions), a vacuum suction means 110, and a base element 112. During regular operation, the vacuum gripper 100 is held by the handle 104 such that the base element 112 may be held against an object surface (not shown), and the vacuum suction means 110 may be activated either by the automatic power on/off switch 102 (which automatically starts and stops the vacuum suction means 110 to maintain vacuum conditions under the base element 112) or the manual power switch 106. The vacuum suction means 110 creates a vacuum between the base element 112 and the object surface, causing the vacuum gripper 100 to be held firmly against the object surface.

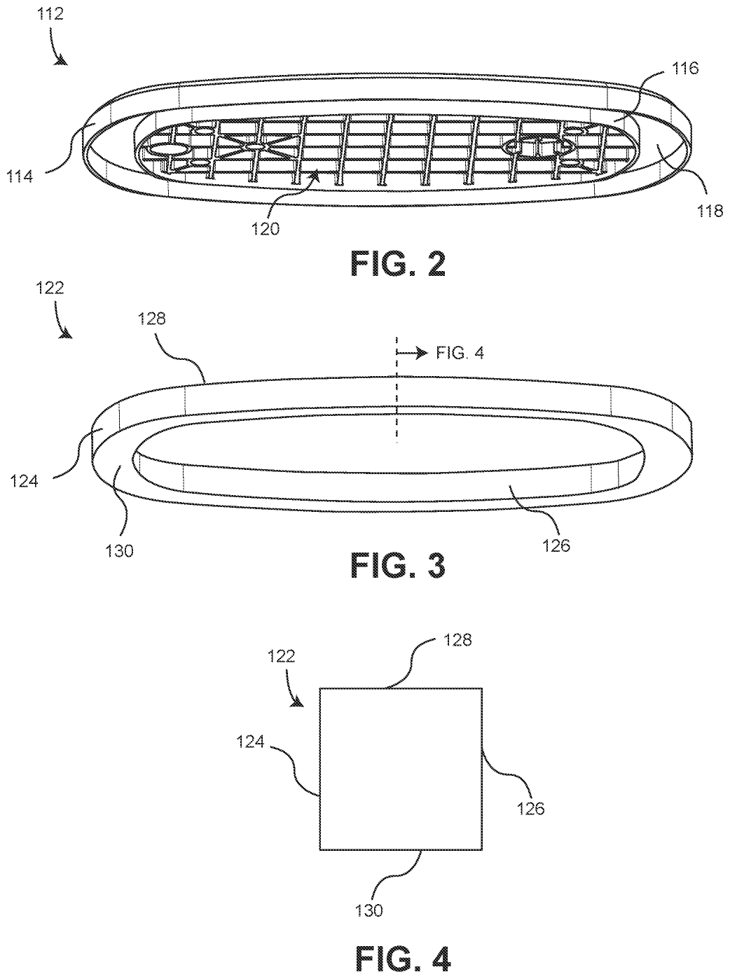

Reference is now made to FIG. 2, which is a bottom view of a base element 112 of the vacuum gripper 100 of FIG. 1. The base element 112 comprises an upper wall 113, an outer wall 114, an inner wall 116, a receiving surface 118, and a honeycomb support structure 120. A sealing element may be mountable to the receiving surface 118, the sides of which sealing element may at least be partially covered by the outer wall 114 and the inner wall 116. The honeycomb support structure 120 provides a degree of rigidity to the upper wall 113 and the base element 112 overall while preventing bending of the upper wall 113 and inner wall 116 during operation.

Reference is now made to FIG. 3, which is an example of a sealing element 122 which may be mountable to the base element 112. The sealing element 122 may be a loop-shaped component with a typically rectangular or annular profile pattern. The sealing element 122 comprises an outer edge 124 which may be partially covered by the outer wall 114 and an inner edge 126 which may be partially covered by the inner wall 116. The sealing element 122 also comprises a mounting surface 128 mountable to, for example, the receiving surface 118 of the base element 112. The sealing element 122 also comprises a contact surface 130 which directly contacts an object surface when pressed thereagainst.

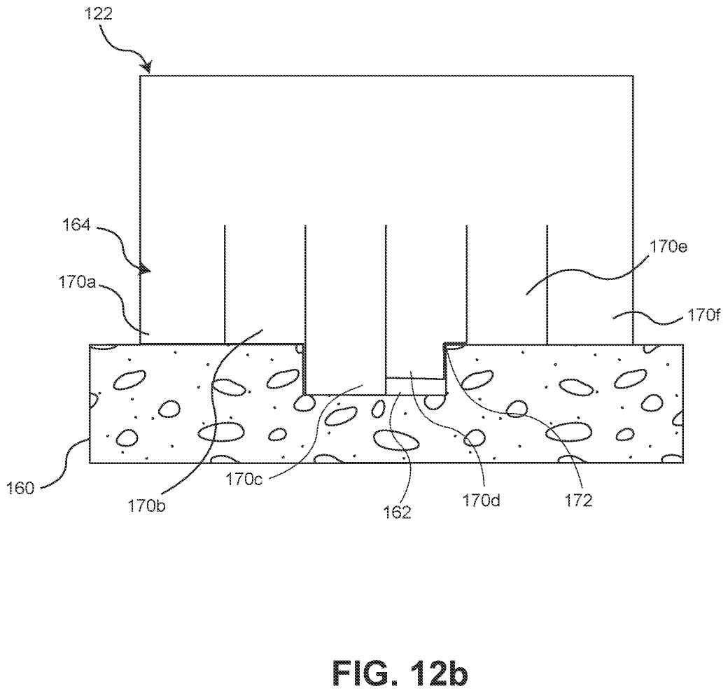

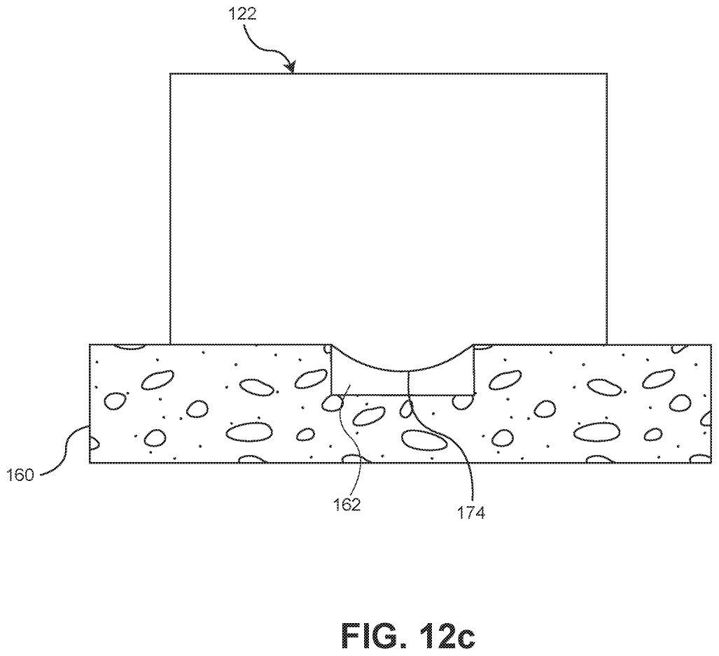

Reference is now made to FIG. 4, which is a cross section diagram of the sealing element 122. Generally speaking, the sealing element 122 is usually made of a compressible material, such as foam or rubber, and is a continuous, unbroken material so that gaps are not created which can let air leak into the chamber defined by the upper wall 113 of the base element 122, the inner wall 116 of the base element 112, and an object surface. However, as described previously, continuous contact surfaces exhibit a surface tension that prevents stretching of the contact surface around or within irregularities in an object surface (see FIG. 12C). Although it seems counter-intuitive, applying patterned cuts to the sealing element 122 (i.e., the outer edge 124, the inner edge 126, and/or the contact surface 130) improved the grip of the sealing element 122 by breaking up that surface tension, effectively dividing the sealing element 122 into more granular segments and allowing those granular segments to individually react to irregular surface topology. This segmentation of the sealing element 122 improved the gripping strength of the vacuum gripper 100 regardless of the material used (foams, rubbers, silicon, etc.).

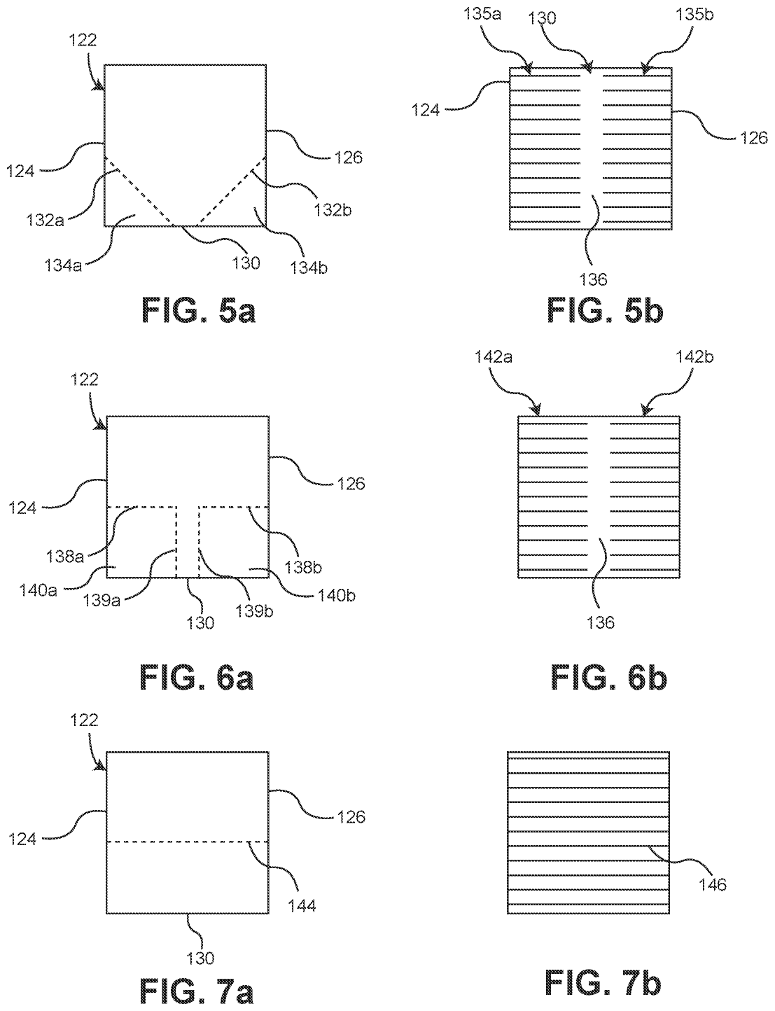

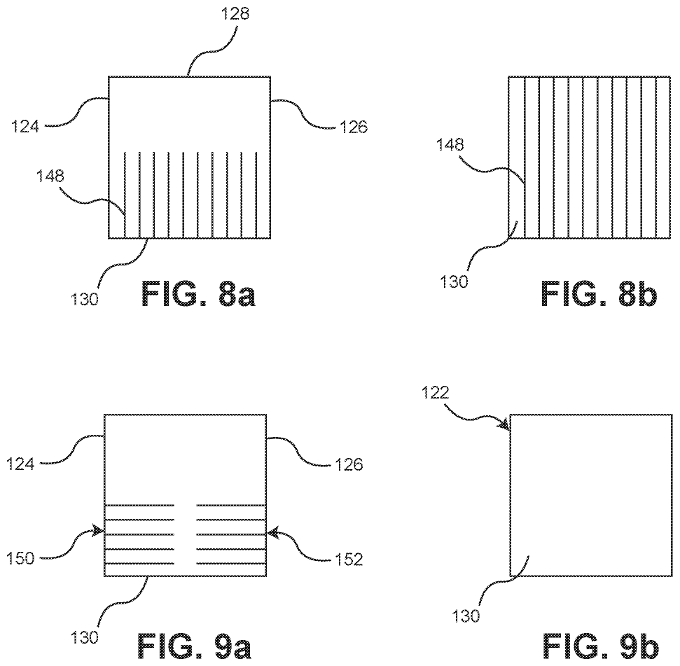

In one or more embodiments, the sealing element 122 comprises a segmentation pattern which divides the sealing element 130 into a plurality of compressible segments. A “segmentation pattern” may refer to a pattern of one or more divisions of the sealing element 122 made by, for example, making one or more cuts along the contact surface 130, the outer edge 124, and/or the inner edge 126. In the accompanying drawings, broken lines in FIGS. 5a-7a delineate at least part of the cross-sectional area of the divisions in the sealing element 122 and solid lines show a one-dimensional perspective of the divisions as seen on the contact surface 130 (as in FIGS. 5b-9b) or a cross section of the sealing element 122 (as in FIGS. 8a-9a).

Referring to FIG. 5a a cross-section view of a sealing element 122 with an angled segmentation pattern is shown. An angled segmentation pattern may involve: one or more divisions of the sealing element 122 made by making cuts along the outer edge 124 and the contact surface 130 up to a segmentation line 132a spanning from the outer edge 124 to the contact surface 130; and/or one or more divisions of the sealing element 122 made by making cuts along the inner edge 126 and the contact surface 130 up to a segmentation line 132b spanning directly from the inner edge 126 to the contact surface 130. The cut area 134a and the cut area 134b may represent parts of the sealing element 122 that may be considered potential expansions to the contact surface 130.

From a contact surface 130 view (i.e., bottom view of sealing element 122 of FIG. 5a) as shown in FIG. 5b, the angled segmentation pattern may involve dividing the sealing element 122 along the segmentation lines 135a and the segmentation lines 135b. As shown, the cuts that form the angled segmentation pattern extend from the outer edge 124 to nearly middle of the contact surface 130 and from the inner edge 126 to nearly middle of the contact surface 130. In this embodiment, the segmentation lines 135a and 135b do not meet since they culminate at the contact surface 130 at different points. This preserves a middle section 136 of the contact surface 130, preventing air from entering from the outer edge 124 and passing through the inner edge 126. Due to the ability of the contact surface 130 to break up its continuity along the segmentation lines 135a-b, some or all of the cut areas 134a-b are effectively added to the surface area of the contact surface 130.

Although the angled segmentation pattern is shown as a symmetrical pattern, it may be asymmetrical—the angled segmentation pattern may comprise divisions that span from the outer edge 124 to the contact surface 130 or only divisions that span from the inner edge 126 to the contact surface 130. Or, if there are cuts from both sides, they may be uneven. In any case, this type of segmentation pattern may also be called a ‘partial cut’, in that the cut only partially passes through the width of the sealing element 122. A cut that passes fully from the outer edge 124 to the inner edge 126 may be known as a ‘full pass cut’ or ‘full cut’.

Referring now to FIG. 6a, a cross-section view of a sealing element 122 having a straight cut segmentation pattern is shown. A straight cut segmentation pattern may involve one or more divisions of the sealing element 122 made by making cuts along the contact surface 130 up to a horizontal segmentation line 138a and/or along the outer edge 124 up to a vertical segmentation line 139a. In addition or in the alternative, the straight cut segmentation pattern may involve one or more divisions of the sealing element 122 made by making cuts along the contact surface 130 up to a horizontal segmentation line 138b and along the outer edge 124 up to a vertical segmentation line 139b. Horizontal segmentations lines 138a and 138b may be parallel with the contact surface 130 and vertical segmentation lines 139a and 139b may be parallel with the outer edge 124 and/or the inner edge 126. The cut area 140a and the cut area 140b may be square or rectangular-shaped as a result. Although the straight cut segmentation pattern shown in FIG. 6a involves two simple straight cuts, the straight cut segmentation pattern may involve any number of straight cuts limited by horizontal and vertical segmentation lines.

From a contact surface 130 view (i.e., bottom view of sealing element 122 of FIG. 6a) as shown in FIG. 6b, the straight segmentation pattern may involve dividing the sealing element along the segmentation lines 142a and the segmentation lines 142b. As shown, the cuts that form the straight segmentation extend from the outer edge 124 to nearly middle of the contact surface 130 and from the inner edge 126 to nearly middle of the contact surface 130. In this embodiment, the horizontal segmentation lines 138a and 138b do not meet since they culminate at vertical segmentation lines 139a and 139b respectively. This preserves a middle section 136 of the contact surface 130, preventing air from entering from the outer edge 124 and passing through the inner edge 126. Although the angled segmentation pattern is shown as a symmetrical pattern, it may be asymmetrical—the angled segmentation pattern could consist only of divisions that span from the outer edge 124 to the contact surface 130 or only divisions that span from the inner edge 126 to the contact surface 130.

Referring now to FIG. 7a, a cross-section view of a sealing element 122 with a full pass segmentation pattern is shown. A ‘full pass’ cut is a segmentation pattern that extends fully from the outer edge 124 to the inner edge 126. In addition, the full pass segmentation pattern shown in FIG. 7a also extends from the contact surface to a segmentation line 144. The segmentation line 144 may or may not be parallel with the contact surface 130. From a contact surface 130 view (i.e., the bottom of the sealing element 122 of FIG. 7a) as shown in FIG. 7b, the full pass segmentation pattern may involve dividing the sealing element 122 along the segmentation lines 146.

Referring now to FIG. 8a, a cross-section view of a sealing element having a segmented contact surface is shown, according to one or more embodiments. As shown, the segmented contact surface 130 may be formed by applying vertical cuts with respect to the contact surface 130 extending from the contact surface 130 and toward the mounting surface 128. Referring to FIG. 8b, a contact surface 130 view of the sealing element 122 of FIG. 8a is shown. As shown in FIGS. 8a-b, the segmented contact surface may involve vertical segmentation lines 148 which may be parallel with each other and the outer edge 124 and the inner edge 126. These extend throughout the length of the contact surface 130 and effectively split the contact surface 130 into individual vertical segments.

Referring now to FIG. 9a, a cross-section view of a sealing element having a segmented outer edge 150 and/or a segmented inner edge 152 is shown, according to one or more embodiments. The segmented outer edge 150 may be formed by applying horizontal cuts into the outer edge 124 of the sealing element 122 and the segmented inner edge 150 may be formed by applying horizontal cuts into the inner edge 126. From a contact surface view (i.e., the bottom of sealing element 122) as shown in FIG. 9b, both the segmented outer edge 150 and/or the segmented inner edge 152 do not show visible segmentation lines since the sealing element 122 in FIG. 9a-b is not segmented along the contact surface 130.

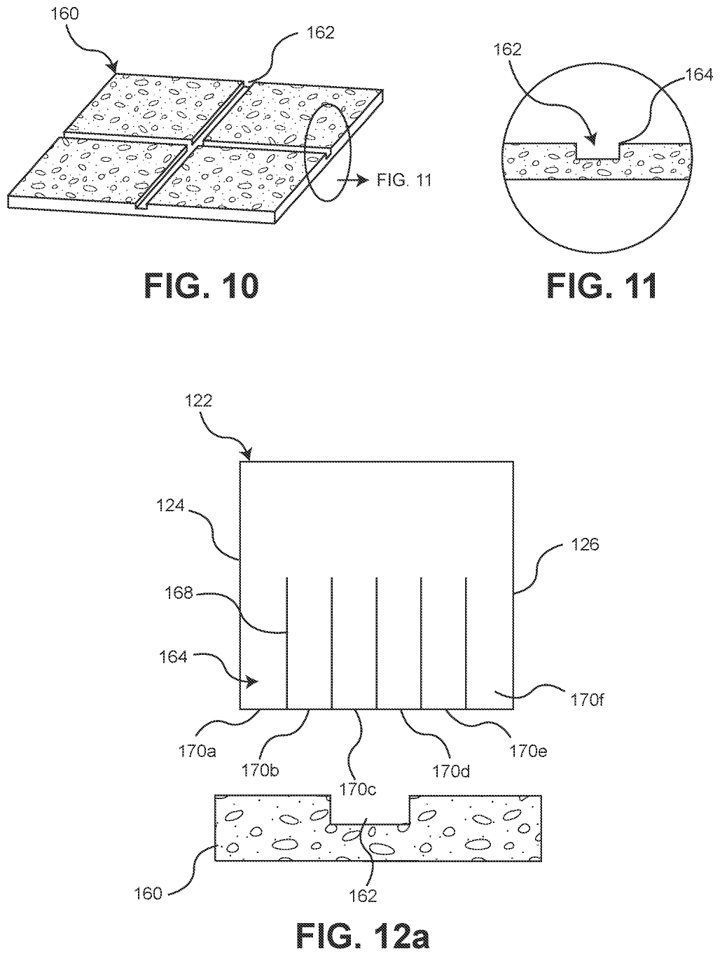

Referring now to FIG. 10, a perspective view of an exemplary rough, porous surface 160 having one or more grooves 162 is shown, according to one or more embodiments. The object of the present invention is to provide a sealing element which provides improved performance when gripping not only rough, porous surfaces such as the rough, porous surface 160 but also surfaces with further physical features that cause the vacuum gripper to lose gripping ability. These physical features, such as grooves and protrusions, usually involve sharp changes in the surface that a continuous surface cannot completely fill or wrap around to create a flush contact. By applying a segmentation pattern to the sealing element, vacuum gripper performance is greatly improved by drastically reducing the amount of air entering the vacuum gripper between the sealing element and the object surface. In many cases, a perfectly flush contact, though ideal, is an overestimation of what is necessary to create a strong grip on an object surface. In other words, the segmentation pattern of the sealing element significantly reduces the threshold for establishing a grip on an object surface by allowing the segments of the sealing element to individually separate (to the extent that they can) and fill in the space within voids in the object surface such as grooves and holes or flexibly wrap around sharp edges or accommodate projections from the object surface. This improves performance of the vacuum gripper by reducing an operational intensity and/or duration required of the vacuum suction means 110.

Referring now to FIG. 11, a cross-section view of the rough, porous surface 160 showing irregular surface topology 162 is shown, according to one or more embodiments. In one embodiment, the irregular surface topology 162 may have sharp edges, deep corners, or other irregular physical features on which a continuous, though compressible or elastic, surface creates a weak seal under pressure. In another embodiment, the irregular physical feature 162 may be a protrusion having similarly sharp corners or edges. Referring to FIG. 12a, a cross-section diagram of a sealing element 122 having a segmented contact surface 164 is shown. The segmented contact surface 164 may be split by cutting the sealing element 122 along the vertical segmentation lines 168 (similar to FIGS. 8a-b). These vertical segmentation lines 168 split the contact surface 130 into individual vertical segments 170a-f which increase the granularity of the segmented contact surface 164, allowing it to more easily grip the rough, porous surface 160.

Referring now to FIG. 12b, a cross-section diagram of the sealing element 122 of FIG. 12a in contact with the rough, porous surface 160 of FIG. 11 is shown. During operation, the vacuum gripper may operate a vacuum suction means 110 which may cause the sealing element 122 to be compressed against the rough, porous surface 160, subsequently causing the segmented contact surface 164 to also compress. However, the individual vertical segments 170a-f may individually compress to different degrees based on the types of physical features of the rough, porous surface 160 the individual vertical segments 170a-f are pressed directly against. For example, the vertical segments 170a-b, e-f may compress more than vertical segments 170c and 170d because the entire width of vertical segment 170c fits within the irregular surface topology 162 (e.g. a groove as shown in FIG. 11-12c). However, vertical segment 170d may not fit fully width-wise into its corresponding section of the irregular surface topology 162. The vertical segment 170d may come into contact with a sharp feature 172 such as a 90-degree corner of the irregular surface topology 162. A portion of the vertical segment 170d may be limited by the sharp feature 172 but the remaining portion of the vertical segment 170d may proceed into the groove 162 although not as fully as the vertical segment 170c. Even though the vertical segment 170d is held back partially by the sharp feature 172, it may only leave a small gap which still successfully limits air flow. Or the gap may be completely filled, as is usually the case with compressible materials usually used in sealing elements. The air flow may be limited to the extent that the sealing element's 122 grip on the rough, porous surface 160 is not compromised because the vacuum suction means 110 still evacuates air from within the confines of the inner edge 126 at a rate faster than air entering through the reduced air gap between the irregular physical feature 162, the vertical segment 170d and the rough, porous surface 160.

Referring now to FIG. 12c, a sealing element 122 having a continuous contact surface 174 without a segmentation pattern is shown used on a rough, porous surface 160 having an irregular physical feature 162. As shown, the contact surface 174 comes into contact with the rough, porous object surface 160 and although much of the contact surface 174 compresses due to the contact, the portion of the contact surface 174 which overlies the irregular physical feature 162 may only slightly bulge if anything due to its being held back by the portions of the contact surface 174 which are in contact with the object surface. Accordingly, the irregular physical feature 162 remains largely unfilled and a flow of air passing through the groove 162 may overcome that of the vacuum suction means, causing the grip of the sealing element 122 to fail. In the above-described embodiments, applying a segmentation pattern to the sealing element 122 increases the granularity of the contact surface and directly reduces the cross-section area of the gaps formed between the contact surface and the rough, porous surface 160.

What is claimed is:

1. A vacuum gripper sealing element comprising:
a mounting surface of the sealing element mountable to a receiving surface of a vacuum gripper base element;
a contact surface of the sealing element opposite to the mounting surface and joined to the mounting surface through an outer edge and an inner edge,
a segmentation pattern dividing the vacuum gripper sealing element into a plurality of compressible segments which individually conform to one or more irregularities of an object surface when the contact surface is pressed thereagainst.

2. The vacuum gripper sealing element of claim 1:
wherein the segmentation pattern involves one or more divisions spanning from the outer edge to the contact surface.

3. The vacuum gripper sealing element of claim 1:
wherein the segmentation pattern involves one or more divisions spanning from the outer edge to the inner edge.

4. The vacuum gripper sealing element of claim 1:
wherein the segmentation pattern involves one or more divisions spanning partially along a cross-section of the vacuum gripper sealing element.

5. The vacuum gripper sealing element of claim 2:
wherein the segmentation pattern additionally involves one or more divisions spanning from the inner edge to the contact surface symmetrically to the one or more divisions spanning from the outer edge to the contact surface.

6. The vacuum gripper sealing element of claim 5:
wherein the one or more divisions include vertical divisions and horizontal divisions with respect to the contact surface.

7. The vacuum gripper scaling element of claim 2:
wherein the segmentation pattern involves one or more divisions spanning from the outer edge to the contact surface; and
wherein the segmentation pattern also involves one or more divisions spanning from the inner edge to the contact surface.
